(19) United States
(12) Patent Application Publication
(10) Pub. No.: US 2026/0205171 A1
(43) Pub. Date: Jul. 16, 2026

(54) SINGLE RADIO UNIT, A SINGLE BASEBAND AND STACK TO SERVE MULTIPLE SECTORS

(71) Applicant: WISIG NETWORKS PRIVATE LIMITED, Madinaguda (IN)

(72) Inventors: Sibgath Ali Khan Makandar, Hyderabad (IN); Pavan Kumar Reddy MANNE, Bhongir (IN)

(21) Appl. No.: 19/449,552

(22) Filed: Jan. 15, 2026

(30) Foreign Application Priority Data
Jan. 16, 2025 (IN) 202541003842

(51) Int. Cl. H04B 7/0456; H04B 7/0452

(52) U.S. Cl. CPC H04B 7/0456; H04B 7/0452

(57) ABSTRACT

Embodiments of the present disclosure are related an open radio access network (ORAN) based base station (BS). The BS comprising at least one radio unit (RU) comprising a plurality of antenna ports, at least one distributed unit (DU) and an interface for a communication between said RU and said DU. The RU is configured to support one or more virtual sub-sectors simultaneously, wherein each virtual sub-sector cover a pre-defined geographical area in both horizontal and vertical directions. Each virtual sub-sector is associated with a specific set of antenna ports of the RU. Each virtual sub-sector provides a coverage for one of distinct geographical areas and partially overlapping geographical areas. The DU associates a UE with a virtual sub-sector. The DU performs at least one of a SU-MIMO within a virtual sub-sector for a UE associated with said virtual sub-sector, and a MU-MIMO across the UEs in different virtual sub-sectors.

### CROSS-REFERENCE TO RELATED APPLICATIONS

This application claims priority from the Indian Provisional Patent Application No. 202541003842, filed on 16 Jan. 2025, the entirety of which are hereby incorporated by reference.

### TECHNICAL FIELD

Embodiments of the present disclosure are related, in general to communication, but exclusively relate to single radio unit, single baseband and stack to serve multiple sectors.

### BACKGROUND

A baseband unit (BU) is typically connected to a radio unit (RU) through a front-haul (FH) link, enabling seamless communication and efficient data processing. The RU features multiple physical antenna ports, each physical antenna port connects to an antenna feed that excites one or more antenna elements, which are interconnected in elevation and azimuth directions to form a sub-array. This sub-array creates a specific radiation pattern. In some cases, an electrical phase shift, known as electrical tilt, which is applied to control the elevation of the radiation pattern. In massive MIMO setups, individual antenna ports directly excite sub-arrays arranged in a 2D-antenna array format (elevation and azimuth). Further, the 5G deployments adhere to 3GPP 5G NR specifications.

The ORAN standards define several interfaces between the DU and RU, such as 7.2A, 7.2B, 7.2C, ULPI class A, and ULPI class B.

7.2A Option: This option is used for configurations like 1TR, 2TR, 4TR, and 8TR. Here, the DU performs baseband precoding, and the precoded signals are transmitted to the RU via an eCPRI front-haul (FH). The RU's low-PHY layer maps these signals to its antenna ports, without additional beamforming. In 7.2A, common channels such as SSB, PDCCH, and PDSCH (before RRC connection) are typically transmitted via a single antenna port.

7.2B Option: In this method, the DU calculates precoder weights, which are then signaled to the RU. The DU sends un-precoded data streams to the RU, where precoding is applied. In uplink (UL), processing differs for 7.2B. The RU applies a receiver beamforming filter that reduces the incoming 16/32/64 receiver streams (from receiver antenna ports) to a maximum of eight effective receiver streams, a process known as port reduction. These reduced streams are sent to the DU, where channel estimation, equalization, and decoding occur. Further, there are 2 classes (ULPI Class-1 and Class-2). In ULPI Class-1: DMRS-based channel estimation and equalization occur in the RU, reducing the port count. Further equalization happens in the DU. In ULPI Class-2: The RU performs DMRS-based channel estimation and full equalization, sending fully processed signals ready for LLR processing in the DU.

In typical 7.2A systems employing 2TR, 4TR or 8TR radios, three remote radio units (RUs) are used one for each sector, each connected via eCPRI front-haul (FH) to the baseband unit (BU). Baseband processing is performed independently for each sector, as 3GPP specifications dictate sector-based processing (using sector IDs). Each RU includes an ORAN FH interface, low-PHY, digital pre-distortion (DPD), ADC/DAC, and an RF front end with components like a power amplifier (PA), LAN, and switch (for TDD configurations). Each RU supports either four or eight antenna ports, depending on whether it's a 4TR or 8TR RU. Each antenna port connects to an external antenna with a unique radiation pattern defined by the physical orientation of the antenna. Typically, a physical vertical tilt is applied, and an electrical tilt can also be set through the SMO/DU using m-plane messages. The antenna includes the necessary electronics and firmware to control the electrical tilt. Typical antenna gain ranges from 13-18 dB, depending on carrier frequency and vertical and horizontal beam width. Most antennas have two ports: one for horizontal (H) and one for vertical (V) polarization. In some cases, dual-polarized antennas may use circular polarization.

In 7.2B or ULPI systems, antennas typically operate with 32TR or 64TR radios, and the baseband unit provides precoding and beamforming support in both downlink (DL) and uplink (UL). Some of the typical features and procedures include are discussed as follows. In TDD systems, the DU receives sounding reference signals (SRS) from each antenna port (e.g., 32/64 TR) transmitted by one or more UEs periodically. The DU estimates the channel state information (CSI) of these UEs, which the scheduler uses for SU or MU MIMO precoder calculations. The RU then applies the precoder as indicated by the DU. In FDD systems, UEs may use CSI-RS signals to feed back the CSI to the DU, which then uses this information for SU or MU MIMO. In SSB beam sweeping, base station forms narrow beams in the azimuth or elevation plane, increasing range by focusing energy toward a specific UE for both common and data channels. Another feature is sector-splitting where a 120-degree sector can be split into two 60-degree sectors by combining specific antennas with tailored weights. The RU and DU then create two different sectors with separate sector IDs, effectively doubling the protocol stack, baseband, FH, and low-PHY instances.

In urban areas, where higher capacity is essential, 32TR or 64TR radios are frequently used to extend capacity and range. In contrast, rural areas or areas with lower user density commonly deploy 4TR or 8TR radios, which are generally less costly than massive MIMO setups with 32TR or 64TR. In rural and remote areas or micro cells, particularly in regions with low population density or limited budget, there is a demand for significantly lower-cost equipment. For instance, in some regions, rural villages often require a single base station to provide wireless internet access for 100-200 households. Therefore, there is a need to address the aforementioned issue, and provide base stations that offer lower cost and lower complexity.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure an open radio access network (ORAN) based base station (BS) is disclosed. The BS comprising at least one radio unit (RU) comprising a plurality of antenna ports, at least one distributed unit (DU) and an interface for a communication between said RU and said DU. The RU is configured to support one or more virtual sub-sectors simultaneously, wherein each of the one or more virtual sub-sectors cover a pre-defined geographical area in both horizontal and vertical directions. Each of the one or more virtual sub-sectors is associated with a specific set of antenna ports of the RU. Each of the one or more virtual sub-sectors provide coverage for one of distinct geographical areas and partially overlapping geographical areas. The DU associates a UE with a virtual sub-sector, wherein the DU performs at least one of a SU-MIMO within a virtual sub-sector for a UE associated with said virtual sub-sector, and a MU-MIMO across the UEs in different virtual sub-sectors.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1A shows a block diagram of a base station, in accordance with an embodiment of the present disclosure;

FIG. 1B shows a block diagram of ORAN based Base station, in accordance with another embodiment of the present disclosure;

FIGS. 2A-2B shows an example illustration of sub-sectoral configurations with 4 transmit receive (4TR) RU of the ORAN based BS;

FIGS. 3A-3F illustrates common channel transmission for four sub-sectors and three sub-sector cases, with a 4TR RU;

FIG. 4 shows an illustration of sector selection process, in accordance with an embodiment of the present disclosure;

FIG. 5A shows a flowchart illustrating SRS-based UE to sub-sector mapping, in accordance with an embodiment of the present disclosure;

FIG. 5B-5C shows an illustration of c-plane, u-plane data stream between the RU and the DU, in accordance with an embodiment of the present disclosure;

FIG. 6A-6B shows an illustration of scheduling in MU-MIMO and SU-MIMO modes;

FIG. 6C shows an illustration of a precoder selection based on SRS;

FIG. 6D shows an illustration of a precoder selection based on SRS estimates for different UEs;

FIG. 6E shows an illustration of a CSI feedback based joint precoder selection, in an embodiment;

FIG. 6F shows an illustration of a CSI feedback based precoder selection, in an embodiment;

FIG. 7A shows an illustration of bottom-to-top resource allocation;

FIG. 7B shows an illustration of top-to-bottom resource allocation;

FIG. 8 shows an illustration of uplink equalization, in accordance with an embodiment of the present disclosure; and

FIG. 9 shows an illustration of increase in control channel capacity in downlink (DL)/uplink (UL), in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Embodiments of the present disclosure are related to a low-cost and a low-complexity design enabling single radio unit to serve multiple sectors. In urban areas, where higher capacity is essential, 32 Transmitter/Receiver (TR) or 64TR radios are frequently used to extend capacity and range. In contrast, rural areas with lower user density commonly deploy 4TR or 8TR radios, which are generally less costly than massive multiple input multiple output (MIMO) setups with 32TR or 64TR. In rural and remote areas, particularly in regions with low population density or limited budget, there is a demand for significantly lower-cost equipment. For instance, in some regions, the rural villages often require a single base station to provide wireless internet access for 100-200 households. To address the aforementioned issue, a single 4TR/8TR RU is used to serve multiple sub-sectors. Further, to support or enhance, various procedures are used, such as sector assignment and precoding of users based on CSI RS and SRS transmissions.

In one embodiment, a cost-effective communication system that leverages ORAN 7.2 specifications and a 7.2A-compliant RU without modifications to the RU, 3GPP specifications, or User Equipment is provided. Also, the communication system introduces adjustments to the DU baseband. The communication system is a base station (BS) or gnB.

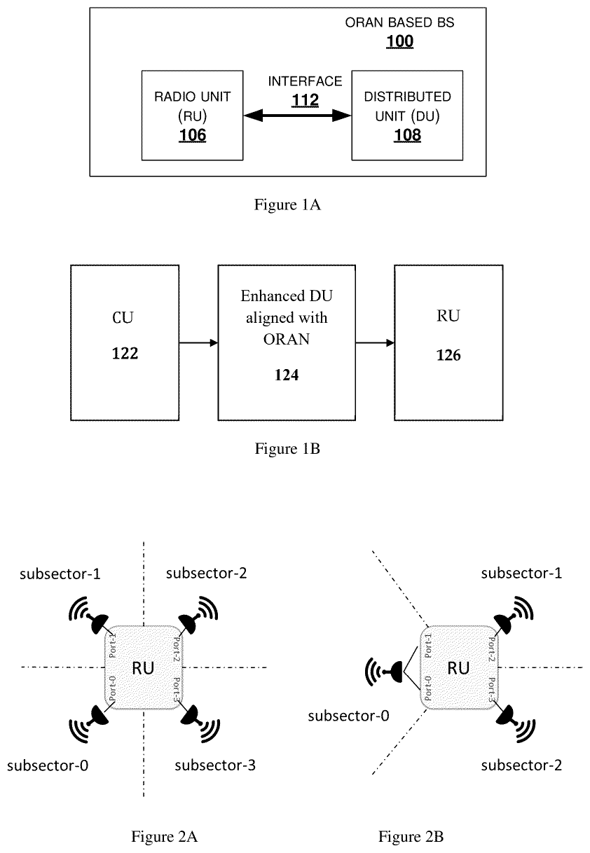

Embodiments of the present disclosure an open radio access network (ORAN) based Base Station (BS) is disclosed. FIG. 1A shows a block diagram of a base station, in accordance with an embodiment of the present disclosure. As shown in the FIG. 1A, the BS is an ORAN based BS 100, comprising at least one radio unit (RU) 106, at least one distributed unit (DU) 108 and an interface 112 for a communication between said RU and said DU. In an embodiment, the BS comprise a central unit (CU). The RU 106 comprises a plurality of antenna ports (not shown in the Figure). The interface 112 is an ORAN 7.2A compliance fronthaul interface, said ORAN 7.2A fronthaul interface is a single fronthaul link between the DU and the RU.

The RU 106 is configured to support one or more virtual sub-sectors simultaneously, wherein each of the one or more virtual sub-sectors cover a pre-defined geographical area in both horizontal and vertical directions. Each of the one or more virtual sub-sectors is associated with a specific set of antenna ports of the RU. Each of the one or more virtual sub-sectors provide coverage for one of distinct geographical areas and partially overlapping geographical areas.

The RU comprises a plurality of physical antennas, said antennas are arranged in sectoral pattern to serve multiple virtual sub-sectors. In an embodiment, each antenna port supports at least one virtual sub-sector. The virtual sub-sectors handled by the RU is one of 2, 3, 4, 5, 6, 7, and 8. Each virtual sub-sector provides one of 45°, 60°, 90°, 120°, 180°, and 360° coverage in azimuth and elevation. The RU is associated with a single sector-id irrespective of number of virtual sub-sectors. The UEs associated with any of the virtual sub-sectors are referenced using the sector id associated with an RU.

The RU 106 simultaneously transmits common signaling information across all virtual sub-sectors, wherein the associated antenna ports of each virtual sub-sector transmit the same information. The common signaling information is at least one of a master information, a system information, cell related broadcast information, one or more synchronization signals, and downlink common control information. The virtual sub-sector may also be referred as sub-sector or subsector in the present disclosure.

The RU 106 transmits the common signaling information by one of the antenna ports only corresponding to the virtual sub-sector, when multiple antenna ports are associated with the virtual sub-sector. The RU is associated with a single sector-id irrespective of number of virtual sub-sectors or one or more virtual sub-sectors. Each antenna port supports one or more antenna ports, wherein each antenna port supports at least one virtual sub-sector. The RU is a CAT-A RU, wherein a subsector precoder is applied on downlink signals in the DU, said the subsector precoder is not applied on the downlink or the uplink signals in the RU.

The DU 108 associates a UE with a virtual sub-sector, i.e. the DU 108 performs at least one of SU-MIMO within a virtual sub-sector for a UE belong to that virtual sub-sector, and MU-MIMO across the UEs in different virtual sub-sectors. The SU-MIMO is used for both uplink (UL) and downlink (DL) transmissions. Also, the MU-MIMO is used for both UL and DL transmissions.

The DU 108 classifies all active connected users into different virtual sub-sectors, thereby manages a data communication for the UEs through respective virtual sub-sectors. Also, the DU 108 maintains a virtual sub-sector identifier (id), with each virtual sub-sector being assigned a unique identifier. The mapping of a virtual sub-sector to a user or user equipment (UE) is performed by the DU using a sector selection process. UEs associated with any of the virtual sub-sectors are referenced using the sector id associated with the RU but not the virtual sub-sector id. The communication and other signaling between the DU and the UEs is performed based on the sector id.

The mapping of a virtual sub-sector to a user is performed by the DU 108 using a sector selection process. The sector selection process is performed using at least one of sounding reference signals (SRS), channel state information reference signals (CSI-RS), and synchronization signal block (SSB) beams.

In an embodiment, the DU 108 configures the transmission of the SRS for all user equipment (UE) connected to the BS in SRS-based sector selection process. The SRS corresponding to a plurality of users are received on all the antenna ports of the RU. Based on the estimated channel state information (CSI) from the SRS, the respective channel power per sub-sector is computed by the DU and each UE is mapped to one of the subsectors, selecting the subsector with the highest received channel power.

In an embodiment, the DU 108 performs the CSI-RS based sector selection process. This process comprises transmitting distinct CSI-RS signals on distinct virtual subsectors. For a given UE located in a virtual subsector, the UE receives the associated CSI-RS signal with highest power and the UE feedbacks an index of the respective CSI-RS signal to the DU. The DU receives CSI-RS signal index feedback with highest received power associated with each of the UEs A unique correspondence exists between the CSI-RS index and a virtual sub-sector. Thereafter, the DU performs mapping each UE to a respective virtual subsector based on the received CSI-RS signal index.

In an embodiment, the DU 108 performs the SSB beam based sector selection process, which comprises transmitting distinct SSB beams by the DU on distinct subsectors, wherein the UE identifies the strongest SSB beam and performs all the subsequent procedures associated with the selected SSB beam, wherein a unique correspondence exists between the SSB beams and the virtual sub-sectors. The UEs associated with any of the virtual sub-sectors are referenced using the sector id associated with an RU but not the virtual sub-sector id, wherein the communication and other signaling between the DU and the UEs is performed based on the sector id.

FIG. 1B shows a block diagram of ORAN based Base station, in accordance with another embodiment of the present disclosure. As shown in the FIG. 1B, the BS comprises a central unit (CU), a radio unit (RU) and a distributed unit (DU). The DU is an enhanced DU aligned in compliance with the ORAN. The DU is a conventional ORAN compliant DU comprising scheduler with enhancements to support multiple virtual sub-sectors. Also, said DU performs sector assignment to one or more UEs. The assigned sectors is based on a precoder selection process.

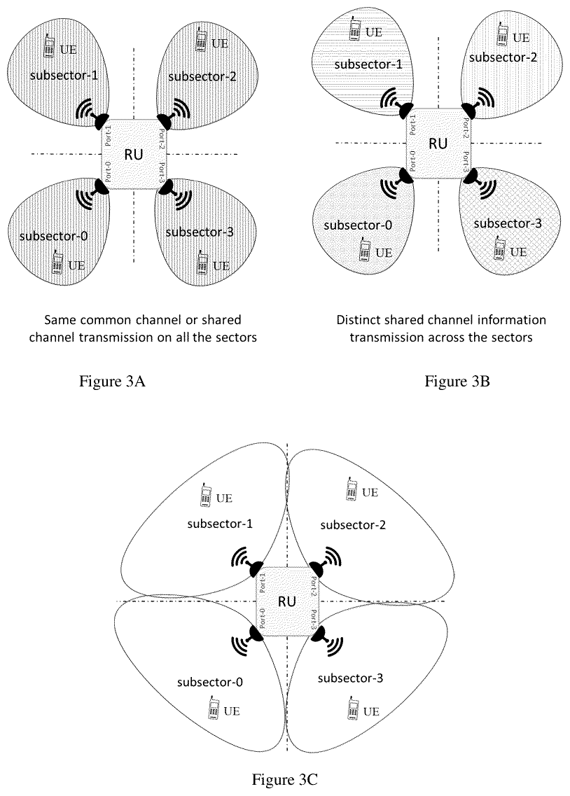

FIGS. 2A-2B shows an example illustration of sub-sectoral configurations with 4 transmit receive (4TR) RU of the ORAN based BS. As shown in FIGS. 2A and 2B, the BS comprises a single 4TR RU and up to four sub-sectoral antennas positioned to provide 360-degree coverage in azimuth and the required elevation coverage. The 7.2A-compliant RU connects to a DU via front-haul (FH), and the DU assigns a single sector ID to the entire BS. The DU provides four antenna ports, and the sub-sectors are arranged in either of the following configurations:

In an example embodiment, considering 4TR system with four sub-sectors, each with a single antenna port, providing a 90-degree azimuthal coverage pattern, as shown in the FIG. 2A. Each sub-sector port directly maps to one of the four RU ports as follows:
Port-0→Subsector-0
Port-1→Subsector-1
Port-2→Subsector-2
Port-3→Subsector-3

In another example with 4TR system, a different arrangement where Subsector-0 covers 120 degrees in azimuth with two ports, while Subsectors 2 and 3 have a single antenna port each, covering 120 degrees in azimuth, as shown in FIG. 2B.
Port-0 and Port-1→Horizontal and vertical ports of Subsector-0, respectively
Port-2→Subsector-2
Port-3→Subsector-3

One embodiment of the present disclosure is an 8TR Extension. There are two types or options for 8TR extensions. In option 1, the 8TR RU ports are divided into four sub-sectors, each with two antenna ports (H and V), with a 90-degree azimuth radiation pattern per sub-sector.

In option 2, the 8TR RU ports are divided into three sub-sectors. Sub-sector-0 has four ports, while sub-sectors 1 and 2 have two ports each. Each sub-sector has a 120-degree azimuth pattern. The number of sub-sectors supported by a single RU (either 4TR or 8TR RU) is one of 2, 3, 4, 5, 6, 7, and 8. Further, one sub-sector covers one of 45°, 60°, 90°, 120°, 180°, and 360° coverage in azimuth and elevation. Additionally, the antenna port set supporting one sub-sector may have one of 1, 2, 4, and 8 antenna ports.

In an embodiment, all the three sub-sector transmissions in DL and UL uses sector ID for signal generation, messages and signaling. Sub sector ID is specific to DU and RU operation but UE is not aware of sub sector ID. Only the BS, also referred as gNb, divides one cell that uses one RU, one sector ID to create multiple physical sectors.

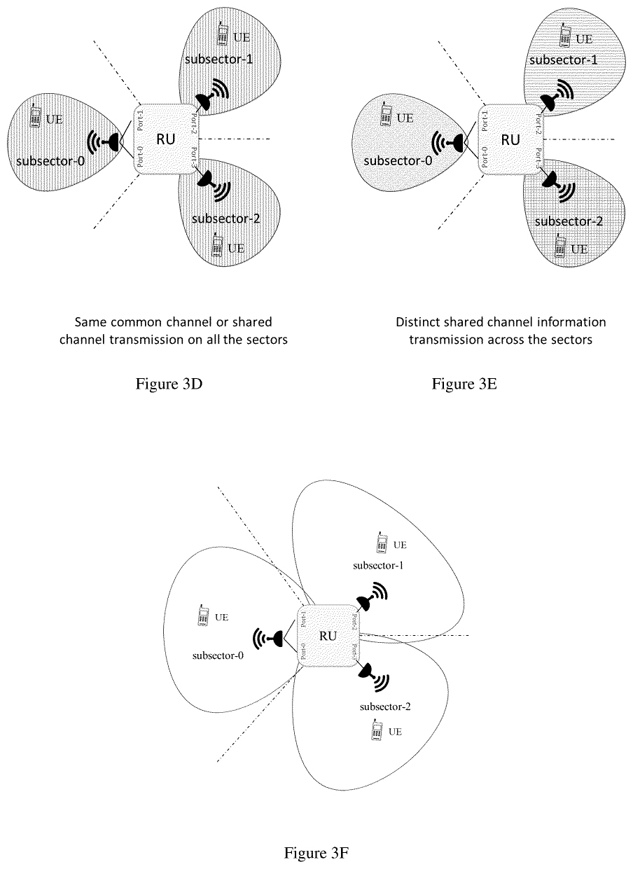

FIGS. 3A-3F illustrates common channel transmission for four sub-sectors and three sub-sector cases, with a 4TR RU. All the common signaling information such as, but not limited to system information, synchronization signals, common control information, will be transmitted in all the sub-sectors simultaneously, with each of the sub-sector transmitting same common signaling information. Further, if multiple antenna ports serve any given sub-sector, the common information, also referred to as common signaling information, is transmitted on one of the antenna ports. That is, the common signaling information such as, but not limited to Synchronization Signal Block (SSB) which includes Primary Synchronization Signal (PSS), Secondary Synchronization Signal (SSS), and Physical Broadcast Channel (PBCH), are transmitted across all the sub-sectors using a single antenna port, using two methods/configurations.

In a first configuration referred to as Configuration A, each of the four ports/sub-sectors transmits the same SSB, as shown in FIGS. 3A, 3B and 3C. Until radio resource control (RRC) attach, physical downlink control channel (PDCCH) and physical downlink shared channel (PDSCH) are also transmitted on a single antenna port in each sub-sector.

In a second configuration, also referred to as configuration B, all three sub-sectors transmit the same SSB, as shown in FIGS. 3D, 3E and 3F. In Subsector-0, one of the two ports carries the SSB while the other transmits a null signal. The other sub-sectors, each with a single port, also carry the SSB. Similarly, until RRC attach, PDCCH and PDSCH are transmitted on a single antenna port in each sub-sector. After the RRC attach, the PDCCH, which carries common cell information, continues to be transmitted on a single antenna port as in the case of the SSB.

FIGS. 3C and 3F illustrate common channel transmission for four sub-sectors and three sub-sector cases, with a 4TR RU having partially overlapping geographical areas.

One embodiment of the present disclosure is a downlink shared channel transmission. A user or UE association to subsector is carried out based on either CSI-RS feedback, SRS-based estimation, or SSB beam based.

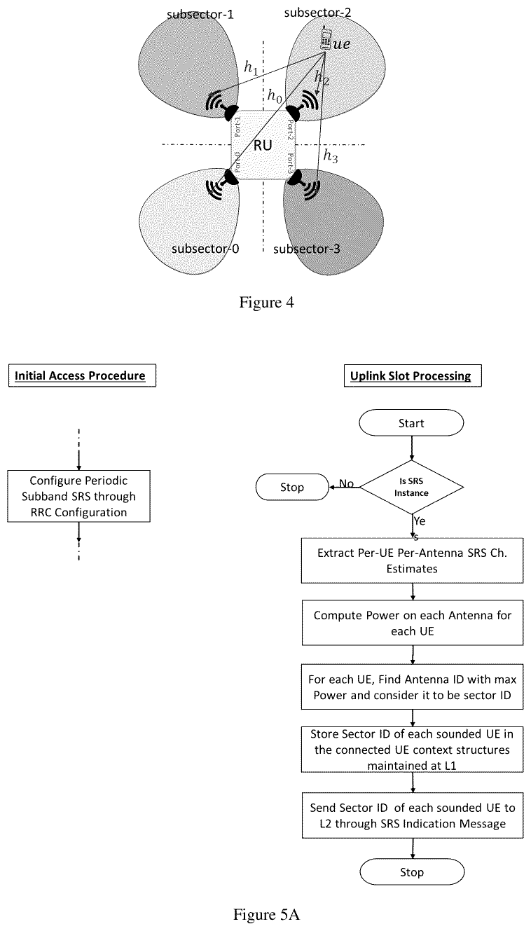

FIG. 4 shows an illustration of sector selection process, in accordance with an embodiment of the present disclosure. In the sector selection process, a distributed unit (DU) configures transmission of SRS for all the connected users. The SRS signals from the users are received on all the antenna ports of RU. Based on the estimated channel state information from the SRS, the respective channel power per sub-sector is computed and each UE is mapped to one of the subsectors, selecting the subsector with the highest received channel power. The antenna port for PDSCH transmission is determined by the sub-sector to which the UE is assigned.

For SRS-based UE to sub-sector mapping, the base station instructs UEs in all sub-sectors to transmit SRS. The SRS signals are received on all four antenna ports, and based on the estimated channel state information of the SRS, the appropriate receive/transmit antenna or sub-sector for each UE may be determined using the following:

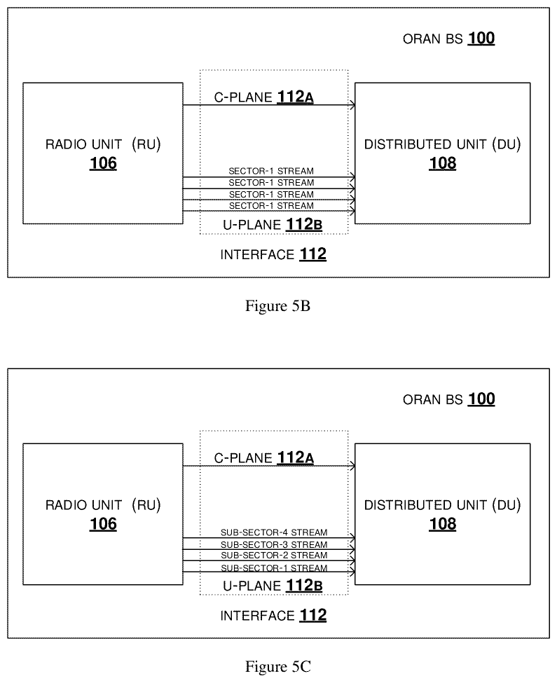

FIG. 5A shows a flowchart illustrating SRS-based UE to sub-sector mapping, in accordance with an embodiment of the present disclosure.

In configuration A, each UE is mapped to one of the four antenna ports, selecting the port with the highest received power.

In configuration B, the received power from ports 0 and 1 is combined and compared to the received power from ports 2 and 3 to determine the sub-sector to which the UE belongs.

The following is the procedure which is as shown in FIG. 5A:
Step 1: Configuring periodic sub-band SRS through RRC Configuration.
Step 2: If SRS Instance, L1 may process each sub-band and obtain per UE per Antenna Channel Estimates.
Step 3: computing power on each antenna for each UE using

$${P}_{j}^{u} = {\sum }_{i = 1}^{k} {\vert {h}_{i}^{u} \vert}^{2}$$

$$where j = Antenna Index , u = UE Index , k = No . of Subcarriers$$

Step 4: determining the antenna (port) number with highest power which will be considered to be the sector ID

$$S ( u ) = {max}_{j} {P}_{j}^{u}$$

Step 5: Update the Sector ID of each sounded UE in the UE Context.
Step 6: sector-ID of the sounded UEs will be communicated to L2 through SRS Indication Message.
Step 7: Repeat step-2 to step-6 for each SRS Instance

In CSI-RS based method, distinct CSI-RS beams are transmitted from the ports associated with distinct subsectors. The user then measures the received signal power on all the active CSI-RS beams and reports the best CSI-RS beam, which subsequently may be used to associate the subsector to each user. In the said sector selection process, the DU transmits distinct CSI-RS on distinct subsectors. The users decode these CSI-RS signals, and feedback the subsector index with highest received power. Accordingly, each UE is mapped to the respective subsector.

One embodiment of the present disclosure is a SSB beam based method. Similar to the CSI-RS procedure, in the SSB beam based sector selection process, the DU transmits distinct SSB beams on distinct subsectors. There exists a unique correspondence between SSB beams and sub-sectors. The user performs all the subsequent procedures on the selected strong SSB beam.

FIG. 5B-5C shows an illustration of c-plane, u-plane data stream between the RU and the DU, in accordance with an embodiment of the present disclosure. As shown in the FIGS. 5B-5C, the user plane information transmitted in a single fronthaul link between DU and RU in conventional systems corresponds only to one sector, whereas user plane information transmitted in a single fronthaul link between DU and RU in proposed system corresponds to multiple virtual subsectors.

A scheduler in the BS allocates all downlink (DL) common information, such as SSB, PDCCH, and PDSCH (up to RRC attach), through single-port transmission across all sub-sectors (referred to as cell broadcast). The services like HARQ and SPS may also use cell broadcast or sub-sector-specific transmissions. The PDSCH scheduling utilizes UE-to-sub-sector mapping information to direct PDSCH transmission to antenna ports specific to each sub-sector. The scheduler groups UEs by their associated sub-sectors and applies sub-sector-specific PDSCH scheduling, ensuring fairness and quality of service (QoS) among users in each sub-sector. The scheduler prioritizes allocating orthogonal frequency and time resources for each sub-sector's users. As traffic load increases, overlapping time-frequency resources may be used to enable MU-MIMO across sub-sector users.

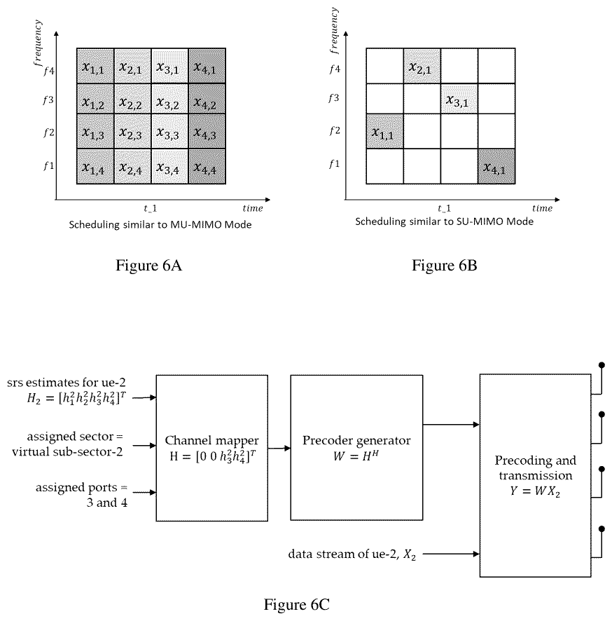

FIG. 6A-6B shows an illustration of scheduling in MU-MIMO and SU-MIMO modes. The scheduler enables interference free communication across the subsectors using transmit precoding. In an embodiment of the present disclosure, a transmit precoding is employed to ensure that the distinct sets of antenna ports cover distinct geographical area without any mutual interference.

For example, in a 4TR system, the data of sub-sector 1 may be transmitted using [1 0 0 0] precoder and the data of sub-sector 2 is transmitted using [0 1 0 0] precoder, and so on, which is as shown in the FIGS. 6A-6B. The scheduler shares the precoder information to physical layer, which subsequently applies on the modulated symbols. The scheduler uses all-one's precoder ([1 1 1 1]) to transmit common signaling information, which enables the same information to be transmitted to all subsectors. The transmit precoder, also referred as precoder, is applied in the DU or the RU depending upon the CAT-A or CAT-B RU. For CAT-A RU, precoder is applied in the DU, whereas for CAT-B, precoder is applied in RU. For CAT-B RU, the precoding vector/matrix is indicated by the DU.

In an embodiment, the transmit precoding is employed to ensure that the distinct sets of antenna ports cover distinct geographical area to reduce mutual interference. The BS comprises a transmit precoder that is configured to ensure that signals transmitted in each sector are exclusively directed to user equipment (UE) or user within the corresponding virtual subsector. The transmit precoder is determined using one of a sounding reference signal (SRS) channel estimate or channel state information reference signal (CSI-RS) feedback.

The channel estimates derived from the SRS for the corresponding antenna ports are used to compute the transmit precoder for a specific UE, depending on the selected virtual sub-sector. For a UE associated with a virtual subsector the transmit precoder is derived using the SRS channel estimates of the antenna ports, only belonging to the said virtual subsector.

For example, considering an 4TR ORAN based BS system comprising two virtual sub-sectors, wherein each virtual sub-sector is configured with 2 antenna ports, if the channel estimates of UE determined using SRS based process are

$$[ {h}_{1}^{1} {h}_{2}^{1} {h}_{3}^{1} {h}_{4}^{1} ] ,$$

where

$${h}_{i}^{1}$$

represents channel estimate on the i^{th} antenna port for UE, and said UE is associated with a virtual sub-sector 1 configured with antenna port-0 and antenna port-1, then the transmit precoder for the

$$UE is W = {[ {h}_{1}^{1} {h}_{2}^{1} 00 ]}^{H} .$$

The transmit precoder for a specific user equipment (UE) is determined using the CSI feedback received from the UE and the corresponding antenna ports associated with the selected virtual sub-sector.

For example, considering an 4TR ORAN based BS system with 2 virtual sub-sectors where each virtual sub-sector is configured with 2 antenna ports, wherein the precoder matrix reported by a UE is

$${[ {w}_{1}^{1} {w}_{2}^{1} {w}_{3}^{1} {w}_{4}^{1} ]}^{T}$$

and corresponding virtual sub-sector 1 configured with antenna port-0 and antenna port-1, then the transmit precoder for said specific UE is

$$W = [ {w}_{1}^{1} {w}_{2}^{1} 00 ] .$$

FIG. 6C shows an illustration of a precoder selection based on SRS. In an embodiment, considering that the ORAN based BS is a 4TR system comprising two virtual sub-sectors, wherein each virtual sub-sector is configured with 2 antenna ports.

The DU applies a joint transmit precoder on the downlink signals corresponding to the UEs in different virtual subsectors to mitigate inter-virtual-subsector interference. The joint precoder is one of zero forcing (ZF), Minimum Mean Square Error (MMSE) and SVD; said joint precoder is constructed using channel state information (CSI) of the respective UEs, said CSI is derived from one of the SRS and CSI feedback. An independent joint transmit precoder is generated for each physical resource group (PRG), said PRG is configured with one of 1, 2, 4, 8, physical resource blocks (PRBs).

FIG. 6D shows an illustration of a precoder selection based on SRS estimates for different UEs. Considering two virtual sub-sectors: virtual sub sector-1 and virtual sub sector-2, and three UEs: UE-1, UE-2 and UE-3; said UE-1 is associated with virtual sub sector-1, said UE-2 and said UE-3 are associated with virtual sub-sector 2. Also, the UE-1 is scheduled on PRB: 0 and PRB: 1, the UE-2 is scheduled on PRB: 0, the UE-3 is scheduled on PRB: 1.

The SRS-channel estimates of UE-1 is

$${H}_{1} = {[ {h}_{1}^{1} {h}_{2}^{1} {h}_{3}^{1} {h}_{4}^{1} ]}^{T} ,$$

SRS-channel estimates of UE-2 is

$${H}_{2} = {[ {h}_{1}^{2} {h}_{2}^{2} {h}_{3}^{2} {h}_{4}^{2} ]}^{T} ,$$

SRS-channel estimates of UE-3 are

$${H}_{3} = {[ {h}_{1}^{3} {h}_{2}^{3} {h}_{3}^{3} {h}_{4}^{3} ]}^{T}$$

for which the precoder matrix formulation for
PRB: 0 is H=[H₁ H₂]^{T}, W=H^{H}(HH^{H})⁻¹ and
the Precoder matrix formulation for PRB: 1 is H=[H₁ H₃]^{T}, W=H^{H}(HH^{H})⁻¹.

In an embodiment, the joint precoder is constructed using the channel state information feedback (CSI feedback) provided by UE. From the CSI feedback, the effective channel states are obtained by converting the UE PMI reports to channel states matrix H and then a precoder is constructed as follow: W=H^{H}(HH^{H})⁻¹.

FIG. 6E shows an illustration of a CSI feedback based joint precoder selection, in an embodiment. Considering two virtual sub-sectors: virtual sub sector-1 and virtual sub sector-2, and three UEs: UE-1, UE-2 and UE-3. The UE-1 is associated with virtual sub sector-1. The UE-2 and the UE-3 are associated with virtual sub-sector 2. Let, the UE-1 is scheduled on PRB: 0 and PRB: 1, the UE-2 is scheduled on PRB: 0, the UE-3 is scheduled on PRB: 1,
wherein PMI feedback of UE-1 is

$${W}_{1} = {[ {w}_{1}^{1} {w}_{2}^{1} {w}_{3}^{1} {w}_{4}^{1} ]}^{T} ,$$

PMI feedback of UE-2 is

$${W}_{2} = {[ {w}_{1}^{2} {w}_{2}^{2} {w}_{3}^{2} {w}_{4}^{2} ]}^{T} ,$$

PMI feedback of UE-3 are

$${W}_{3} = {[ {w}_{1}^{3} {w}_{2}^{3} {w}_{3}^{3} {w}_{4}^{3} ]}^{T}$$

for which the precoder matrix formulation for PRB: 0 is W=[W₁ W₂] and
the Precoder matrix formulation for PRB: 1 is W=[W₁ W₃].

FIG. 6F shows an illustration of a CSI feedback based precoder selection. In an embodiment, the transmit precoder for a specific user equipment (UE) is determined using the CSI feedback received from the UE and the corresponding antenna ports associated with the selected virtual sub-sector.

A joint transmit precoder is used for a UE in different virtual sub-sectors to mitigate inter-virtual-subsector interference. A different joint transmit precoder is generated for each physical resource group (PRG), wherein each PRG is configured with one of 1, 2, 4, 8, physical resource blocks (PRBs). The joint transmit precoder utilizes channel estimates exclusively from the UEs scheduled in the respective PRGs.

While scheduling the time frequency resources for users in the subsectors the scheduler adapts pseudo-round-robin method, where a predefined number of users of one subsector are scheduled starting with PRBO till PRB N, where PRB allocation for each user is based on the load. The same set of PRBs (PRBO till PRB N) are distributed across the users of the next subsector. However, to minimize the interference, the scheduler adapts top to bottom PRB allocation for some subsectors, and bottom to top PRB allocation for some subsectors, i.e., for some subsectors PRB allocation starts from PRB 0, for others it starts from PRB N.

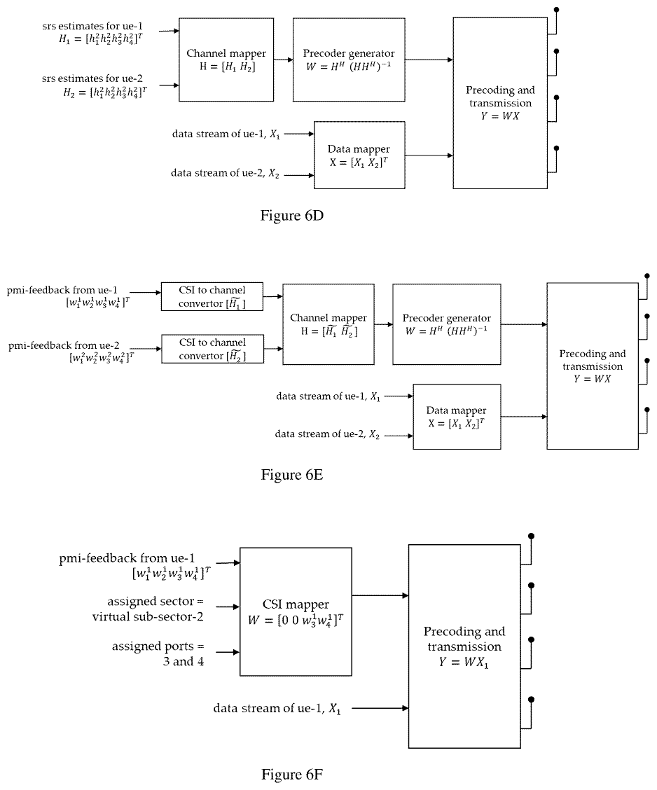

FIG. 7A shows an illustration of bottom-to-top resource allocation. FIG. 7B shows an illustration of top-to-bottom resource allocation.

In an embodiment, for scheduling of the time frequency resources for the UEs in the subsectors, a scheduler adapts the top-to-bottom PRB allocation for some subsectors and bottom-to-top for remaining subsectors. For the top-to-bottom PRB allocation, a predefined number of users of a subsector are scheduled starting with PRB #0 till PRB #N−1, as shown in the FIG. 7A. For the bottom-to-top PRB allocation, a pre-defined number of users of a subsector are scheduled starting from PRB #N−1 till PRB #0, as shown in the FIG. 7B. An inter-subsector interference is minimized by adapting bottom-to-top and top-to-bottom processing across subsectors.

For each scheduled user, the scheduler performs link adaptation, rank adaptation, and precoding based on the sub-sector's antenna configuration. For example:
If two antenna ports are allocated to a user, the DU signals these ports to the sub-sector users, allowing the UE to feedback between rank-1 and rank-2, and applies a 2×1 vector or 2×2 matrix to the sub-sector antenna ports.
If all four antenna ports are signaled to a UE in a specific sub-sector, the UE reports a precoder of size 4×1, 4×2, 4×4, etc. Then, the DU selects an appropriate subset of the precoder matrix for application to the sub-sector's antenna ports.
In another option, the UE feedback corresponding all pseudo sectors is collected, and by selecting the appropriate CSI feedback vector(s), the DU forms a CSI matrix of size 4×s, where s is the number of scheduled layers; and applies a ZF precoder using this 4×s CSI matrix and precodes the “s” layers to 4-streams that are mapped to the 4-ports.

In an embodiment, for a 4TR RU there is a maximum of 4-port DMRS allocation. The DMRS configuration depends on the number of UEs and their distribution across sub-sectors. If four UEs are scheduled, each in a different sub-sector and using the same time-frequency resources, a 4-port DMRS is allocated. If three UEs are scheduled across three sub-sectors, only three of the four DMRS ports are utilized. For two UEs, each occupying a different sub-sector, a 2-port DMRS is allocated. If only one UE is scheduled, one or two DMRS ports are allocated based on the number of ports assigned to that UE.

One embodiment of the present disclosure is an uplink scheduling. Before the RRC attach, the channels PRACH, PUCCH, and PUSCH signals are received on all four receiver antenna ports, as the DU is not yet aware of the UE-to-sub-sector mapping. The receiver processes all four RX port signals using conventional algorithms. For non-coherent detections like PRACH, detection thresholds are optimized, recognizing that only a subset of antenna signals may carry strong signals based on the UE's location.

After RRC attach is done, once the DU has the UE-to-sub-sector mapping, it may refine uplink processing. One embodiment of the present disclosure is a sub-sector scheduling, i.e. SU-MIMO. If the DU treats all uplink transmissions from UEs as a single sector and applies SU-MIMO with non-overlapping resource allocations for each UE, mutual interference across sub-sectors is minimized.

One embodiment of the present disclosure is sub-sector scheduling i.e. MU-MIMO. If the DU schedules each sub-sector's UEs using all available time-frequency resources, an MU-MIMO setup arises with potential inter-sector UE interference.

The following are the UL scheduler options:
Option 1: The UL scheduler treats UEs from all sub-sectors as a single sector, applying a unified UL link adaptation and scheduling.
Option 2: The UL scheduler treats UEs by sub-sector, applying sub-sector-specific link adaptation and scheduling, potentially resulting in UL MU-MIMO across sub-sectors.

One embodiment of the present disclosure is uplink equalization.

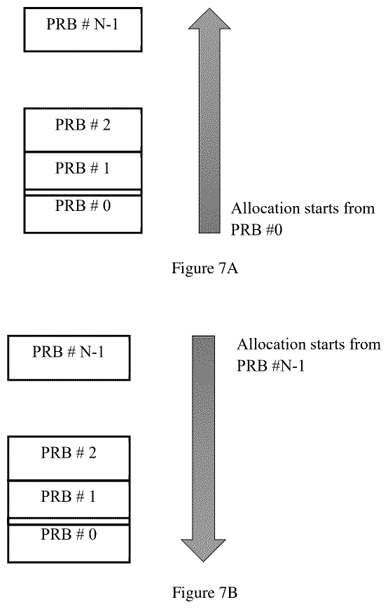

FIG. 8 shows an illustration of uplink equalization, in accordance with an embodiment of the present disclosure. In the DU, the uplink signals from each sub-sector are processed either independently or uplink signals from all subsectors are processed jointly. The DU identifies strongest subsector for each uplink signal using subsector assignment method, and thereby processes that uplink signal using the channel estimates associated with the strongest subsector assigned.

Option 1: The DU divides antenna ports into sub-sector groups, where each sub-sector group processes its received signals for PUCCH and PUSCH equalization, decoding UE information for each sub-sector based on the DMRS assigned to UEs within that sub-sector.

Option 2a: All antenna port signals are processed jointly using a PUCCH or PUSCH equalizer, operating in MU-MIMO mode to decode UE information for all sub-sectors together.

Option 2b: All antenna port signals are jointly processed in SU-MIMO mode, with a PUCCH or PUSCH equalizer decoding UE information for each sub-sector independently. This approach applies the DMRS associated with each UE's sub-sector and repeats for all UEs in each sub-sector.

The uplink synchronization signals such as PRACH are received and processed on all the antenna ports irrespective of number of subsectors. All procedures described for the 4TR case are applicable to the 8TR scenario as well.

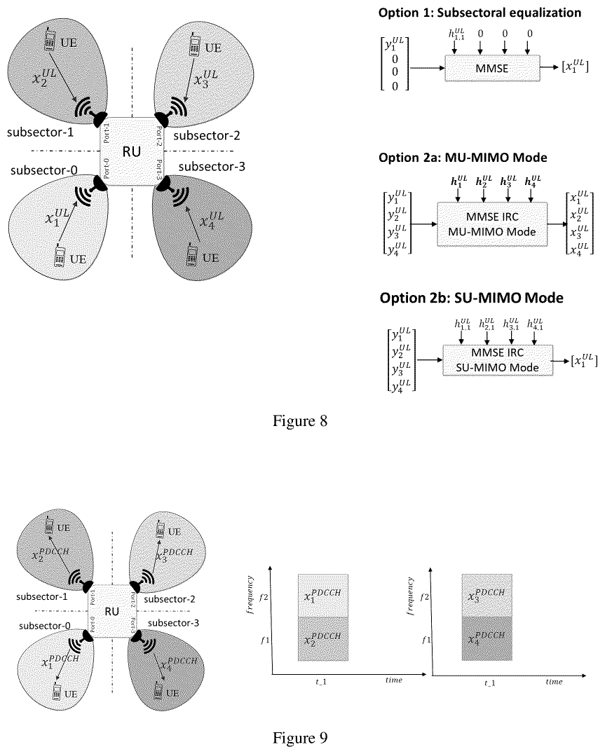

One embodiment of the present disclosure is an increase in control channel capacity in DL/UL. FIG. 9 shows an illustration of increase in control channel capacity in downlink (DL)/uplink (UL), in accordance with an embodiment of the present disclosure. To enhance the control channel capacity, the same time frequency resources are reused by two distinct subsectors to transmit user specific downlink control information. A subsector specific precoder is applied to downlink control information from each subsector to minimize the interference.

For example, the diagonally opposite sectors may reuse the same time frequency resource to transmit downlink control information. In a 4-sector arrangement, user specific PDCCH and PUCCH may be allocated in diagonally opposite sectors. This increases the control channel capacity. DL scheduler may allocate Single port PDCCH transmission. Further, in a similar fashion, the same time frequency resources are reused by two distinct subsectors to receive user specific uplink control information (say PUCCH F0 and F2). For example, the diagonally opposite sectors may reuse the same time frequency resource to receive uplink control information. In a three-sector configuration, the control channels may be reused in each p-sector.

In an embodiment, the DU performs one of SU-MIMO per sub sector UE and MU-MIMO jointly for multiple sub sectors associated with multiple UEs in downlink (DL) or uplink (UL).

In an embodiment, the downlink control information for distinct UEs or users in different subsectors is transmitted over the same time-frequency resources, with a subsector-specific precoder applied to the downlink control information from each subsector to minimize interference. A diagonally opposite sectors reuse the same time frequency resource to transmit downlink control information.

The BS is a MIMO BS in which uplink signals received from each virtual sub-sector are processed independently, in accordance with an embodiment of the present disclosure. Based on the strongest subsector selection method, the MIMO BS identifies the strongest subsector for a specific uplink signal. The MIMO BS processes the uplink signals received only on antenna ports belonging to a virtual subsector. The MIMO BS generates equalized signal streams corresponding to a UE in the associated virtual subsector.

The uplink signals received from all virtual sub-sectors are processed jointly, in an embodiment. The uplink signals from all MIMO BS antenna ports are jointly processed in MU-MIMO mode to generate one or more equalized streams corresponding to one or more user equipment (UEs). The MU-MIMO mode utilizes one of Minimum Mean Square Error (MMSE), MMSE Interference Rejection Combining (MMSE-IRC), MMSE Successive Interference Cancellation (MMSE-SIC), and Zero Forcing (ZF). The MU-MIMO mode includes computation of joint covariance matrix of noise and intra/inter subsector interference. The uplink signals on all MIMO BS antenna ports are processed jointly in SU-MIMO mode to generate one or more equalized streams corresponding to single UE.

In an embodiment, the SU-MIMO mode utilizes one of Minimum Mean Square Error (MMSE), MMSE Interference Rejection Combining (MMSE-IRC), MMSE Successive Interference Cancellation (MMSE-SIC), or Zero Forcing (ZF). The common uplink signals such as PRACH, and SRS received at antenna ports corresponding to each virtual sub-sector are processed jointly. The joint processing is one of a coherent method and non-coherent method. The distinct UEs or users belonging to distinct subsectors simultaneously transmit the uplink control information on the same time frequency resources. The distinct users belonging to the diagonally opposite sectors reuse the same time frequency resource to transmit the uplink control information.

The present disclosure or provided methods leverages existing ORAN and 3GPP standards while introducing minimal adjustments to the baseband unit (DU) and radio unit (RU). The methods for DL/UL scheduling, sector ID mapping, and beamforming are provided to ensure compatibility and scalability across various deployment scenarios. By reducing hardware requirements and enhancing the coverage, the methodology addresses rural low-cost requirements.

In another embodiment of the present disclosure, a user equipment (UE) in an open radio access network (ORAN) based base station (BS) coverage is disclosed. The UE is configured to receive and process a common downlink signals transmitted by the BS. Also, the UE is configured to perform at least one of determining CSI-RS signal with highest received power and feeding back an index of corresponding CSI-RS signal to the BS; and determining a strong SSB beam from all the received SSB signal and feeding back an index of said strong SSB beam to the BS. Also, the UE transmits at least one of SRS signals, the index corresponding to the CSI-RS signal and the index of the strong SSB beam, to the BS.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention. When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1-47. (canceled)

48. An open radio access network (ORAN) based base station (BS) comprising:
at least one radio unit (RU) comprising a plurality of antenna ports;
at least one distributed unit (DU); and
an interface configured to communicate between the RU and the DU, wherein the RU is configured to support one or more virtual subsectors simultaneously, each of the one or more virtual subsectors covers a predefined geographical area in both horizontal and vertical directions,
each of the one or more virtual subsectors is associated with a specific set of antenna ports of the RU,
each of the one or more virtual subsectors provides coverage for one of distinct geographical areas or partially overlapping geographical areas,
the DU associates a user equipment (UE) with a virtual subsector, and
the DU is configured to perform at least one of:
a single-user multiple-input multiple-output (SU-MIMO) within a virtual subsector for a UE associated with the virtual subsector, and
a multiple-user multiple-input multiple-output (MU-MIMO) across the UEs in different virtual subsectors.

49. The BS as claimed in claim 48, wherein one or more of the following apply:
the interface is an ORAN 7.2A-compliant fronthaul interface,
the interface is a single fronthaul link between the DU and the RU, the RU comprises a plurality of physical antennas, the antennas are arranged in a sectoral pattern to serve multiple virtual subsectors,
each antenna port supports at least one virtual subsector,
the virtual subsectors handled by the RU are one of 2, 3, 4, 5, 6, 7, and 8,
each virtual subsector provides one of 45°, 60°, 90°, 120°, 180°, and 360° coverage in azimuth and elevation,
the RU is associated with a single sector-id irrespective of the number of virtual subsectors,
the UEs associated with any of the virtual subsectors are referenced using the sector id associated with the RU,
the RU simultaneously transmits common signaling information across all virtual subsectors, wherein the associated antenna ports of each virtual subsector transmit the same information,
the common signaling information is at least one of a master information, a system information, cell-related broadcast information, one or more synchronization signals, and downlink common control information,
the DU classifies all active connected users into different virtual subsectors, thereby managing data communication for the UEs through respective virtual subsectors,
the DU maintains a virtual subsector identifier (id), with each virtual subsector being assigned a unique identifier,
the UEs associated with any of the virtual subsectors are referenced using the sector id associated with the RU but not the virtual subsector id,
the communication and other signaling between the DU and the UEs is performed based on the sector id,
a transmit precoding is employed to ensure that the distinct sets of antenna ports cover distinct virtual subsectors,
the DU comprises a transmit precoder that is configured to ensure that signals associated with a virtual subsector are directed to the UEs within the virtual subsector,
the DU schedules the UEs in distinct subsectors with the same time-frequency resources,
the uplink signals such as PRACH and SRS received at the antenna ports are processed jointly by a coherent method or a non-coherent method,
the uplink signals received from each virtual subsector are processed independently, only on the antenna ports associated with the virtual subsector, and equalized signal streams are generated corresponding to a UE in the associated virtual subsector,
the downlink control information for distinct UEs in different virtual subsectors is transmitted over the same time-frequency resources, with a virtual subsector-specific precoder applied to the downlink control information from each virtual subsector to minimize interference,
diagonally opposite sectors reuse the same time-frequency resource to transmit downlink control information without any virtual subsector-specific precoder,
the DU schedules the distinct UEs belonging to distinct subsectors to simultaneously transmit the uplink control information on the same time-frequency resources, and
the DU schedules the distinct UEs belonging to the different sectors to reuse the same time-frequency resource to transmit the uplink control information.

50. The BS as claimed in claim 48, wherein the RU transmits the common signaling information using only one of the antenna ports corresponding to the virtual subsector, when multiple antenna ports are associated with the virtual subsector.

51. The BS as claimed in claim 49, wherein:
the RU is a CAT-A RU,
a subsector precoder is applied on downlink signals in the DU, and
the subsector precoder is not applied on the downlink or the uplink signals in the RU.

52. The BS as claimed in claim 48, the mapping of a virtual subsector to a user is performed by the DU using a sector selection process.

53. The BS as claimed in claim 52, wherein the sector selection process is performed using at least one of:
sounding reference signals (SRS),
channel state information reference signals (CSI-RS), and
synchronization signal block (SSB) beams.

54. The BS as claimed in claim 53, wherein the DU configures the transmission of the SRS for all user equipment (UE) connected to the BS in an SRS-based sector selection process.

55. The BS as claimed in claim 54, wherein:
the SRS corresponding to a plurality of users are received on all the antenna ports of the RU, and
based on the estimated channel state information (CSI) from the SRS, the respective channel power per subsector is computed and each UE is mapped to one of the subsectors, selecting the subsector with the highest received channel power.

56. The BS as claimed in claim 53, wherein the CSI-RS based sector selection process comprises:
transmitting, by the DU, distinct CSI-RS signals on distinct virtual subsectors,
a given UE located in a virtual subsector receives the associated CSI-RS signal with highest power, UE feedback index of the respective CSI-RS signal to the DU,
receiving, by the DU, CSI-RS signal index feedback with highest received power associated with each of the UEs, wherein a unique correspondence exists between the CSI-RS index and a virtual subsector, and
mapping, by the DU, each UE to a respective virtual subsector based on the received CSI-RS signal index.

57. The BS as claimed in claim 53, wherein:
the SSB beam based sector selection process comprises transmitting distinct SSB beams, by the DU, on distinct subsectors,
the UE identifies the strongest SSB beam and performs all the subsequent procedures associated with the selected SSB beam, and
a unique correspondence exists between the SSB beams and the virtual subsectors.

58. The BS as claimed in claim 48, wherein for a 4TR system, data of virtual subsector-1 is transmitted using [1 0 0 0] precoder and the data of virtual subsector 2 is transmitted using [0 1 0 0] precoder.

59. The BS as claimed in claim 58, wherein one or more of the following apply:
the transmit precoder is determined by using one of a sounding reference signal (SRS) channel estimate or channel state information reference signal (CSI-RS) feedback,
for a UE associated with a virtual subsector the transmit precoder is derived using the SRS channel estimates of the antenna ports, only belonging to the virtual subsector,
the ORAN based BS is a 4 transmit/receive chain (4TR) system comprising two virtual subsectors, with each virtual subsector comprising 2 antenna ports and if the channel estimates of UE determined using SRS based process are
$$[ {h}_{1}^{1} {h}_{2}^{1} {h}_{3}^{1} {h}_{4}^{1} ] ,$$
where
$${h}_{i}^{1}$$
represents channel estimate on the i-th antenna port for UE, and the UE is associated with a virtual subsector 1 configured with antenna port-0 and antenna port-1, then the transmit precoder for the UE is
$$W = {[ {h}_{1}^{1} {h}_{2}^{1} 00 ]}^{H} ,$$
the transmit precoder for a specific user equipment (UE) is determined using the CSI feedback received from the UE and the corresponding antenna ports associated with the selected virtual subsector, and
the ORAN based BS is 4TR system with 2 virtual subsectors where each virtual subsector is configured with 2 antenna ports, with the precoder matrix reported by a UE is
$${[ {w}_{1}^{1} {w}_{2}^{1} {w}_{3}^{1} {w}_{4}^{1} ]}^{T}$$
and a corresponding virtual subsector 1 is configured with antenna port-0 and antenna port-1, then the transmit precoder for the specific UE is
$$W = [ {w}_{1}^{1} {w}_{2}^{1} 00 ] .$$

60. The BS as claimed in claim 48, wherein the DU applies a joint transmit precoder on the downlink signals corresponding to the UEs in different virtual subsectors to mitigate inter-virtual-subsector interference.

61. The BS as claimed in claim 60, wherein one or more of the following apply:
the joint precoder is one of:
zero forcing (ZF),
Minimum Mean Square Error (MMSE) and
SVD,
the joint precoder is constructed using channel state information (CSI) of the respective UEs that is derived from either the SRS or the CSI feedback, and
a distinct joint transmit precoder is generated for each physical resource group (PRG) that is configured with one of 1, 2, 4, 8, physical resource blocks (PRBs).

62. The BS as claimed in claim 48, wherein the DU comprises a scheduler that adapts a top-to-bottom PRB allocation for some subsectors and bottom-to-top for remaining subsectors, for scheduling the time-frequency resources for the UEs in the subsectors.

63. The BS as claimed in claim 62, wherein one or more of the following apply:
for the top-to-bottom PRB allocation, a predefined number of users of a subsector are scheduled starting with PRBO till PRB N,
for the bottom-to-top PRB allocation, a predefined number of users of a subsector are scheduled starting from PRB N till PRB 0, and
the bottom-to-top and the top-to-bottom processing across subsectors minimizes an inter-subsector interference.

64. The BS as claimed in claim 48, wherein the uplink signals on all MIMO BS antenna ports are processed jointly in SU-MIMO mode to generate one or more equalized streams corresponding to a single UE.

65. The BS as claimed in claim 64, wherein the SU-MIMO mode utilizes one of:
Minimum Mean Square Error (MMSE),
MMSE Interference Rejection Combining (MMSE-IRC),
MMSE Successive Interference Cancellation (MMSE-SIC), and
Zero Forcing (ZF).

66. The BS as claimed in claim 48, wherein the uplink signals received from all virtual subsectors are jointly processed in MU-MIMO mode to generate one or more equalized streams corresponding to one or more UEs.

67. The BS as claimed in claim 66, wherein one or more of the following apply:
the MU-MIMO mode comprises a computation of joint covariance matrix of noise, intra/inter virtual subsector interference and inter cell interference, and the MU-MIMO mode utilizes one of:
Minimum Mean Square Error (MMSE),
MMSE Interference Rejection Combining (MMSE-IRC),
MMSE Successive Interference Cancellation (MMSE-SIC), and
Zero Forcing (ZF).
